(19) United States
(12) Patent Application Publication
(10) Pub. No.: US 2026/0023485 A1
(43) Pub. Date: Jan. 22, 2026

(54) PRE-ERASING MEMORY BLOCKS

(71) Applicant: Micron Technology, Inc., Boise, ID (US)

(72) Inventors: Jameer Mulani, Bangalore (IN); Luis Iam, San Jose, CA (US); Jonathan S. Parry, Boise, ID (US)

(21) Appl. No.: 19/261,510

(22) Filed: Jul. 7, 2025

Related U.S. Application Data
(60) Provisional application No. 63/673,589, filed on Jul. 19, 2024.

(51) Int. Cl. G06F 3/06

(52) U.S. Cl. CPC G06F 3/0619; G06F 3/064; G06F 3/0673

(57) ABSTRACT

Methods, systems, and devices for pre-erasing memory blocks are described. Multiple memory cells of multiple available memory cells may be erased to obtain multiple erased memory cells. Subsequent programming of the multiple erased memory cells may be delayed for a duration. Based on delaying the subsequent programming of the multiple erased memory cells for the duration, the multiple erased memory cells may be programmed.

### CROSS REFERENCE

The present Application for Patent claims priority to U.S. Patent Application No. 63/673,589 by Mulani et al., entitled “PRE-ERASING MEMORY BLOCKS,” filed Jul. 19, 2024, which is assigned to the assignee hereof, and which is expressly incorporated by reference in its entirety herein.

### TECHNICAL FIELD

The following relates to one or more systems for memory, including pre-erasing memory blocks.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports pre-erasing memory blocks in accordance with examples as disclosed herein.

FIG. 2 shows an example of a set of operations for pre-erasing memory blocks in accordance with examples as disclosed herein.

FIG. 3 shows an example of a set of operations for pre-erasing memory blocks in accordance with examples as disclosed herein.

FIG. 4 shows an example of a set of operations for pre-erasing memory blocks in accordance with examples as disclosed herein.

FIG. 5 shows a block diagram of a memory system that supports pre-erasing memory blocks in accordance with examples as disclosed herein.

FIG. 6 shows a flowchart illustrating a method or methods that support pre-erasing memory blocks in accordance with examples as disclosed herein.

### DETAILED DESCRIPTION

A memory system may store, in a continuous powered-off state, data for a time duration at a certain temperature (e.g., for 1 year at 30 Celsius), and may be expected to do so without (or with less than a threshold amount of) data corruption. In such cases, the memory system may be prevented from performing any operations to refresh the programmed threshold voltages of the memory cells and to, thus, reduce or prevent the degradation of the programmed threshold voltages of the memory cells. Accordingly, over the time duration, the data in such a powered-off memory system may become corrupted—in some cases, in violation of customer requirements. Improving the read window budget (RWB) margin of the certain types of memory cells may enable the memory system to store data for the prescribed time duration without (or with less than a threshold amount of) data corruption.

However, existing techniques for improving the RWB margin of the memory cells may be incompatible with other system requirements. Thus, implementations (e.g., methods, systems, apparatuses, techniques, configurations, components) that support improving the RWB margin of the memory cells while maintaining compliance with other system requirements (e.g., latency requirements) may be desired.

To improve the RWB margin of the memory cells while maintaining compliance with other system requirements, techniques for erasing memory cells (e.g., TLCs or QLCs) in advance of programming may be used. For example, techniques that ensure that memory cells are erased for at least a threshold duration of time before programming the erased memory cells with new information may provide an RWB margin improvement that enables the memory system to store data in a powered off state for at least a prescribed duration and prescribed temperature without (or with less than a threshold amount of) data corruption. Moreover, such techniques may be implemented without affecting (or with minimal effect on) other system properties (e.g., such as read latency).

In addition to applicability in memory systems as described herein, techniques for pre-erasing memory blocks may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing a duration that a memory system may retain data while in a powered-off state, which may enable the memory system to comply with longer powered-off data retention requirements, among other benefits.

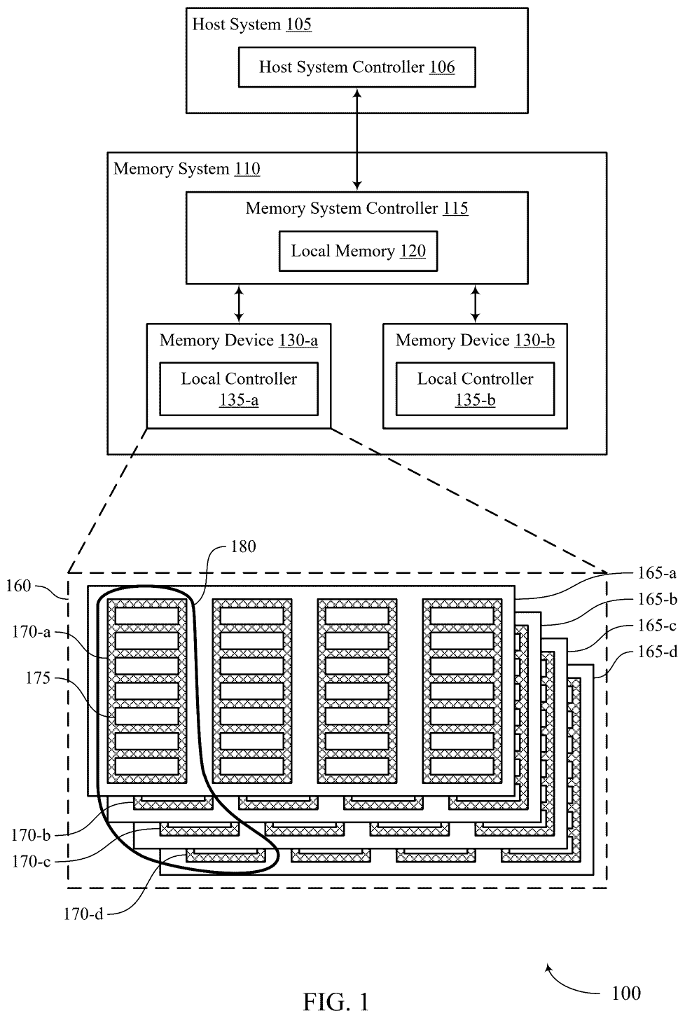

FIG. 1 shows an example of a system 100 that supports pre-erasing memory blocks in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

A memory system may store data in memory cells by programming the memory cells to have discrete logic states that are representative of the data. In some examples, the memory system write data to memory cells by programming threshold voltages of a set of memory cells (e.g., single-level cells (SLCs), bi-level cells (BLCs) (which may also be referred to as multi-level cells (MLCs)), tri-level cells (TLCs), quad-level cells (QLCs), etc.) to have one of multiple (e.g., two, four, eight, sixteen) possible threshold voltages that are representative of the data. Data stored in the memory cells may be accessed by subsequently reading the memory cells. Reading the memory cells may include applying one or more read voltages to the memory cells and sensing resulting outputs from the memory cells that are based on respective differences between the programmed threshold voltages of the memory cells and the one or more read voltages. After reading the data stored in the memory cells, the memory system may output the data to another device (e.g., the host system). In some examples, the memory cells in the memory system may be non-volatile and configured to retain stored data if the memory system loses power. In some examples, despite having non-volatile properties, the data stored in the memory cells may degrade if the memory system is left in the powered-off state for significant periods of time—e.g., months or years.

In some examples, a programming operation may program an incorrect threshold voltage at a memory cell—that is, a programming operation may program an incorrect threshold voltage associated with a different logic state than the logic state intended to be programmed for the memory cell. For example, a threshold voltage programmed for a memory cell may be below a read voltage threshold associated with the intended logic state such that, during a subsequent read operation, the memory cell may erroneously indicate that the memory cells is storing a different logic value than was intended to be written to the memory cell. In some examples, a programmed threshold voltage of a memory cell may satisfy a read voltage threshold after programming but may fall below a read threshold at a later time such that, during a subsequent read operation, the memory cell may erroneously indicate that the memory cells is storing a different logic value than was written to the memory cell.

The memory system may be configured with error correction capabilities that allow the memory system to recover from programming and/or memory cell failures that may occur. In some examples, a threshold quantity of failures may occur before the data written to the memory cells is corrupted beyond recovery. For example, a memory system may be configured such that a threshold quantity of memory cells (which may be based on a power of the error correction scheme) programmed to have first logic states can degrade to have different logic states without loss of data in the memory system.

As one option for reducing a likelihood of uncorrectable errors (e.g., for SLCs), the memory system may program memory cells to have threshold voltages that are more resilient to flaws or failures in the programming process, that occur during data storage, or both. For example, the memory system may program memory cells (e.g., SLCs) to have higher magnitude threshold voltage—e.g., to increase the distance between threshold voltages of memory cells programmed to have different logic states. Such a programming technique may reduce a likelihood of a memory cell being programmed with a threshold voltage that is below a read voltage associated with an intended logic state of the memory cell. Additionally, or alternatively, such a programming technique may reduce a likelihood of a programmed threshold voltage of a memory cell falling below the red voltage associated with the written logic state of the memory cell over time. In another example, the memory system may program memory cells (e.g., for BLCs, TLCs, QLCs, etc.) to narrow a threshold voltage distribution of programmed memory cells—e.g., to increase the distance between the tails of the threshold voltage distributions for the different logic states.

In some examples, the resiliency to flaw or failures is referred to as the “read window budget margin” (e.g., RWB margin) of the memory system, where the available margin is the “budget.” In other words, to reduce a likelihood of uncorrectable errors, the memory system may program memory cells to have a higher RWB margin that reduces a likelihood of programming failures, storage failures, or both of occurring relative to a lower RWB margin. In some examples, the RWB margin may be a function of the error correction scheme employed in the memory system, the distance between threshold voltage distributions for the different logic states that are programmable for memory cells in the memory system, or both.

Some use cases for a memory system may request the memory system to store, in a continuous powered-off state, data for a certain amount of time at a certain temperature (e.g., for 1 year at 30 Celsius) without (or with less than a threshold amount of) data corruption. For example, for surveillance use cases, captured data stored in a powered-off (e.g., full) memory system may be required (e.g., for legal compliance) to be retained for at least one (1) year. In such cases, the memory system may be prevented from performing any operations to refresh the programmed threshold voltages of the memory cells and to, thus, reduce or prevent the degradation of the programmed threshold voltages of the memory cells. Accordingly, over a prescribed time duration, the data in such a powered-off memory system may become corrupted in violation of the requirements of a particular use case. In some examples, only the data stored in certain types of cells in the memory system (e.g., TLCs or QLCs) may become corrupted within the prescribed time period. Improving the RWB margin of the certain types of memory cells may enable the memory system to store data for the prescribed time duration without (or with less than a threshold amount of) data corruption.

But existing techniques for improving the RWB margin of the memory cells may be incompatible with other system requirements. For example, dynamic XOR techniques may be used to improve the RWB margin of the memory cells but may be associated with a latency for reading the memory cells that is prohibited for the memory system (e.g., that exceeds a 100 ms block busy time if the memory system is a micro storage device (microSD) product). Thus, implementations (e.g., methods, systems, apparatuses, techniques, configurations, components) that support improving the RWB margin of the memory cells while maintaining compliance with other system requirements (e.g., latency requirements) may be desired.

To improve the RWB margin of the memory cells while maintaining compliance with other system requirements, techniques for erasing memory cells (e.g., TLCs, QLCs) in advance of programming may be used. For example, techniques that ensure that memory cells are erased for at least a threshold duration of time before programming the erased memory cells with new information may provide an RWB margin improvement that enables the memory system to store data in a powered-off state for at least a prescribed duration and prescribed temperature without (or with less than a threshold amount of) data corruption. Moreover, such techniques may be implemented without affecting (or with minimal effect on) other system properties (e.g., such as read latency).

In some examples, the memory system 110 may erase a set of available (or “free”) memory cells to obtain a set of erased memory cells. In some examples, the set of free memory cells may be included in a “free pool,” and the set of erased memory cells may be included in a “pre-erase pool.” In some examples, the erased memory cells are configured for higher-level (e.g., tri-level or quad-level) programming operations. The memory system 110 may ensure that the set of erased memory cells are included in the pre-erase pool for a minimum duration (e.g., greater than 7 seconds) before the set of erased memory cells are released to a different pool that allows the memory cells to be programmed.

In some examples, the memory system 110 may crase the set of available memory cells in response to receiving a request to write data to the memory system—e.g., if the utilization rate (which may also be referred to as “logical saturation”) of the memory system 110 is below a threshold. In some examples, in response to the write request, the memory system 110 may program first available memory cells to store the data using lower level programming (e.g., SLC, BLC, TLC) programming and subsequently trigger a folding operation to transfer data from the lower-level programmed memory cells to the set of erased memory cells (e.g., to increase an available capacity of the cache). In such cases, the memory system 110 may delay the folding operation until the set of erased memory cells have been included in the pre-erase pool for the minimum duration.

In some examples, the memory system 110 may erase the set of available memory cells in advance (or anticipation of) receiving a request to write data to the memory system—e.g., if the utilization rate (which may also be referred to as “logical saturation”) of the memory system 110 is equal to or above a threshold. In such cases, the memory system 110 may select a quantity of the set of erased memory cells that is based on a consumption rate of the available memory cells and the minimum duration. For example, the memory system 110 may erase a quantity of memory cells that ensures that the set of erased memory cells will be included in the pre-erase pool for the minimum duration before reaching a programming position in the pre-erase pool.

Based on ensuring the programming of the set of erased memory cells are delayed for the minimum duration, the memory system 110 may subsequently program the set of erased memory cells to store data.

By ensuring memory cells (e.g., TLCs or QLCs) are erased for a duration prior to programming, a RWB margin of the memory cells may be improved (e.g., by around 50 mV). In some examples, the RWB margin may improve as the quantity of program erase cycles for the memory cells increased. By improving the RWB margin of the memory cells, the memory system may be capable of complying with strict data retention requirements—e.g., for a certain amount of time at a certain temperature (e.g., for 1 year at 30 Celsius) without (or with less than a threshold amount of) data corruption. Additionally, this technique may be implemented using minimal memory resources (e.g., less than two (2) virtual blocks) and with the same or fewer memory resources than are used for other RWB margin improvement techniques. Moreover, this technique may reduce the need for using more powerful (and more complex) error correction schemes to achieve compliance with the strict data retention requirements.

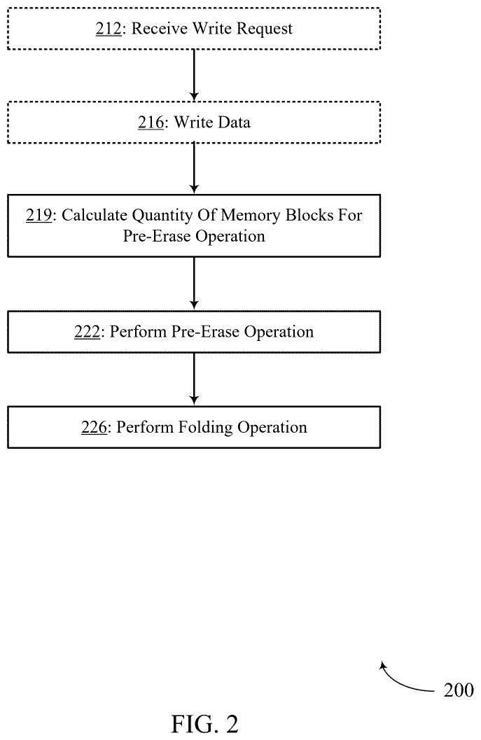

FIG. 2 shows an example of a set of operations for pre-erasing memory blocks in accordance with examples as disclosed herein.

Aspects of the flowchart 200 may be performed by a host system and a memory system, which may be respective examples of the host system 105 of FIG. 1 and the memory system 110 of FIG. 1 described herein. In some examples, the flowchart 200 shows an example set of operations performed to support pre-erasing memory blocks. For example, the flowchart 200 may include operations for pre-erasing memory cells for folding operations in advance of a programming operation and on-demand (e.g., during periods of low or medium logical saturation).

At 212, a request to write a set of data to a memory system may be received. In some examples, the request to write the set of data may be a write command received from a memory system.

At 216, the set of data may be written to one or more pages of one or more first free memory blocks in the memory system. In some examples, the one or more first free memory blocks are included in a group of memory blocks that are configured for caching operations, and the set of data is written to the one or more pages of the one or more first free “caching memory blocks” using lower-order (e.g., SLC, BLC, TLC) programming techniques.

At 219, a quantity of pre-erased memory blocks to make available for folding operations in accordance with the present disclosure may be determined. The pre-erased memory blocks made available for folding operations may be configured for high-density storage operations and may be programmed using higher-order (e.g., BLC, TLC, QLC, etc.) programming techniques. In some examples, the pre-erased memory blocks made available for the folding operations may be generated by pre-erasing “free” memory blocks that are in a ready-for-programming state and included in a “free pool”—e.g., based on an addresses of the memory blocks being stored in a free pool table.

In some examples, the memory system may be triggered to initiate folding operations to transfer data from programmed caching memory blocks to free “high density memory blocks” based on receiving the request to write data to the memory system—e.g., to increase or maintain an amount of space in the cache. As described herein, to obtain an improvement in the RWB margin of the “high-density memory blocks” after the folding operation, the memory system may ensure that the free high-density memory blocks are erased for a pre-erase duration threshold (e.g., are pre-erased) prior to the folding operation. In some examples, the quantity of free high-density memory blocks to pre-erase may be based on a size of the set of data to be written to the one or more first free caching memory blocks; a consumption rate of the cache; a density of high-density memory blocks; a pre-erase duration threshold, a daily high-density memory block consumption for folding operations, refresh operations, garbage collection operations, or any combination thereof—e.g., to ensure that all of the data can be transferred to pre-erased high-density memory blocks.

At 222, one or more high-density memory blocks may be pre-erased (e.g., concurrently with writing the set of data to the one or more pages of the one or more first free memory blocks) at the memory system as a result of receiving the request to write the set of data to the memory system—e.g., in accordance with the determined quantity of high-density memory blocks to erase.

In some examples, one or more second high-density memory blocks may already be pre-erased and included in a “pre-erase” pool—e.g., based on addresses of the memory blocks being stored in a pre-erase table. In such cases, the one or more high-density blocks that are pre-erased may be added to (e.g., to an end of) the pre-erase pool. In some examples, the one or more high-density memory blocks are pre-erased based on a quantity of pre-erased high-density memory blocks in the pre-erase pool being less than the determined quantity of pre-erase blocks. In such cases, a minimum quantity of high-density memory blocks may be maintained in the pre-erase pool such that a pre-erased high-density memory block will be immediately available for folding operations when a subsequent write command is received—e.g., rather than pre-erasing free high-density memory on-demand when write commands are received. In some examples, a memory system may be configured with a quantity of high-density memory blocks already included in the pre-erase pool (e.g., prior to deployment to a customer).

At 226, a folding operation associated with transferring data from one or more caching memory blocks to a portion of the one or more pre-erased high-density memory blocks that have been erased for the pre-erase duration threshold may be performed. In some examples, the folding operation may be performed once all of the high-density memory blocks have been erased for the pre-erase duration threshold.

In some examples, the folding operation may be performed after confirming that at least a portion of the one or more pre-erased high-density memory blocks have been erased for the pre-erase duration threshold. The size of the portion of the one or more pre-erased high-density memory blocks may be selected such that the remaining portions of the one or more high-density memory blocks will have been erased for the pre-erase duration threshold as the folding operation reaches the respective remaining portions—e.g., even if the respective remaining portions have been erased for less than the pre-erase duration threshold when the folding operation begins. In some examples, the size of the portion of the one or more pre-erased high-density memory blocks may be determined based on a calculated consumption rate of the high-density memory blocks for folding operations. For example, if the consumption rate of high-density memory block for a folding operation is around 4 MB/second, a first 4 MB portion of the pre-erased high-density blocks has been erased for the pre-erase duration threshold (e.g., 7 seconds), a second 4 MB portion of the pre-erased high-density blocks has been erased for less than the pre-erase duration threshold (e.g., 6 seconds), and so on, then the folding operation may be initiated as the second portion of the pre-erased high-density memory blocks will have been erased for the pre-erase duration threshold by the time the folding operation reaches the second portion of the pre-erased high-density memory blocks.

Aspects of the flowchart 200 may be implemented by a controller, among other components. Additionally, or alternatively, aspects of the flowchart 200 may be implemented as instructions stored in memory (e.g., firmware stored in a memory coupled with a controller). For example, the instructions, when executed by a controller, may cause the controller to perform the operations of the flowchart 200.

One or more of the operations described in the flowchart 200 may be performed earlier or later, omitted, replaced, supplemented, or combined with another operation. Also, additional operations described herein may replace, supplement or be combined with one or more of the operations described in the flowchart 200.

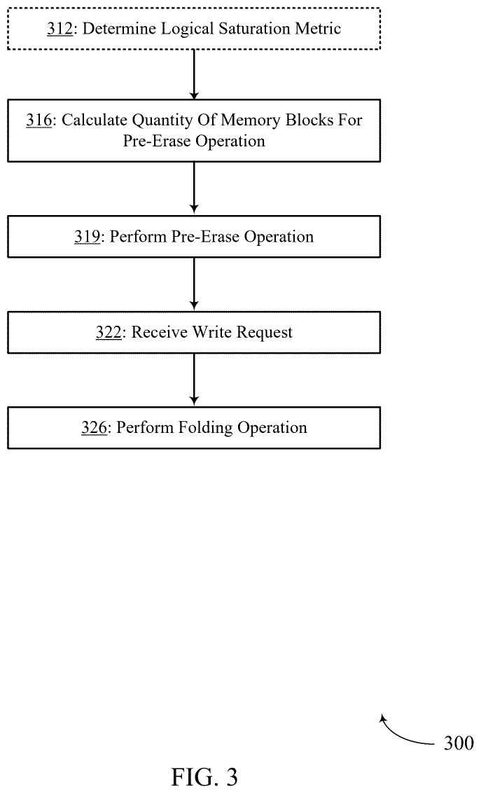

FIG. 3 shows an example of a set of operations for pre-erasing memory blocks in accordance with examples as disclosed herein.

Aspects of the flowchart 300 may be performed by a host system and a memory system, which may be respective examples of the host system 105 of FIG. 1 and the memory system 110 of FIG. 1 described herein. In some examples, the flowchart 200 shows an example set of operations performed to support pre-erasing memory blocks. For example, the flowchart 200 may include operations for proactively pre-erasing memory cells for folding operations in advance of a programming operation (e.g., during periods of high logical saturation).

At 312, it may be determined that a logical saturation of the memory system exceeds a logical saturation threshold. In some examples, it may be determined that the logical saturation of the memory system exceeds the threshold based on an available capacity of the memory system falling below a threshold.

At 316, a quantity of “free” high-density memory blocks to proactively pre-erase may be determined—e.g., based on the logical saturation of the memory system exceeding the logical saturation threshold. In some examples, the memory system may be configured to maintain a minimum quantity of pre-erased high-density memory blocks in a pre-erase pool while in the high logical saturation state.

In some examples, the quantity of high-density memory blocks is based on a quantity of high-density memory blocks already included in the pre-erase pool, a density of high-density memory blocks; a pre-erase duration threshold; and a consumption rate of high-density memory blocks. For example, the high-density memory blocks may be programmed using TLC or QLC techniques and may have a size of 414 MB. Also, while in high logical saturation, the consumption of memory blocks may be around 1 MB/s. Accordingly, it may take around 414 seconds to fully utilize a high-density memory block. If the pre-erase duration threshold is around 12 seconds, then maintaining one (1) to two (2) high-density memory blocks in the pre-erase pool may be sufficient to ensure there are enough pre-erased high-density memory blocks in the pre-erase pool for folding operations. In some examples, two high-density memory blocks may be included in the pre-erase pool so there is a pre-erased high-density memory block waiting to be programmed once the active pre-erased high-density memory block is fully utilized. In some cases, the second high-density memory block may be added to the pre-erase pool when a portion of the first high-density memory block is programmed—e.g., when there is twelve (12) or more seconds less of programming capacity in the first high-density memory block.

In another example, the high-density memory blocks may be programmed using TLC or QLC techniques and may have a size of 414 MB. Also, while in high logical saturation, the consumption of memory blocks may be around 1 MB/s. In this example, if the pre-erase duration threshold is around 800 seconds, then maintaining two (2) to three (3) high-density memory blocks in the pre-erase pool may be sufficient to ensure there are enough pre-erased high-density memory blocks in the pre-erase pool for folding operations. In some examples, (e.g., if there are already one or more pre-erased high-density memory blocks in the pre-erase pool), the calculated quantity of high-density memory blocks may be reduced proportionally.

In some examples, at high logical saturations, a memory system may be configured to perform folding operations at a higher rate to maintain capacity for subsequent write operations from the host device.

At 319, one or more high-density memory blocks may be pre-erased—e.g., in accordance with the determined quantity of high-density memory blocks to erase. In some examples, one or more second high-density memory blocks may already be pre-erased and included in the pre-erase pool. In such cases, the one or more high-density blocks that are pre-erased may be added to (e.g., to an end of) the pre-erase pool. In some examples, the one or more high-density memory blocks are pre-erased based on a quantity of pre-erased high-density memory blocks in the pre-erase pool being less than the determined quantity of pre-erase blocks.

At 322, a request to write a set of data to the memory system may be received. In response to the request, the memory system may write the set of data to one or more caching memory blocks.

At 326, data stored in the caching memory blocks may be transferred to one or more pre-erased high-density memory blocks. In some examples, the data is transferred to the one or more pre-erased high-density memory blocks in accordance with the order in which the one or more pre-erased high-density memory blocks were added to the pre-erase pool. For examples, the data may first be transferred to the pre-erased high-density memory blocks that was first added to the pre-erase pool, then the second pre-erased high-density memory blocks added to the pre-erase pool, then the third pre-erased high-density memory blocks added to the pre-erase pool, and so on.

Aspects of the flowchart 300 may be implemented by a controller, among other components. Additionally, or alternatively, aspects of the flowchart 300 may be implemented as instructions stored in memory (e.g., firmware stored in a memory coupled with a controller). For example, the instructions, when executed by a controller, may cause the controller to perform the operations of the flowchart 300.

One or more of the operations described in the flowchart 300 may be performed earlier or later, omitted, replaced, supplemented, or combined with another operation. Also, additional operations described herein may replace, supplement or be combined with one or more of the operations described in the flowchart 300.

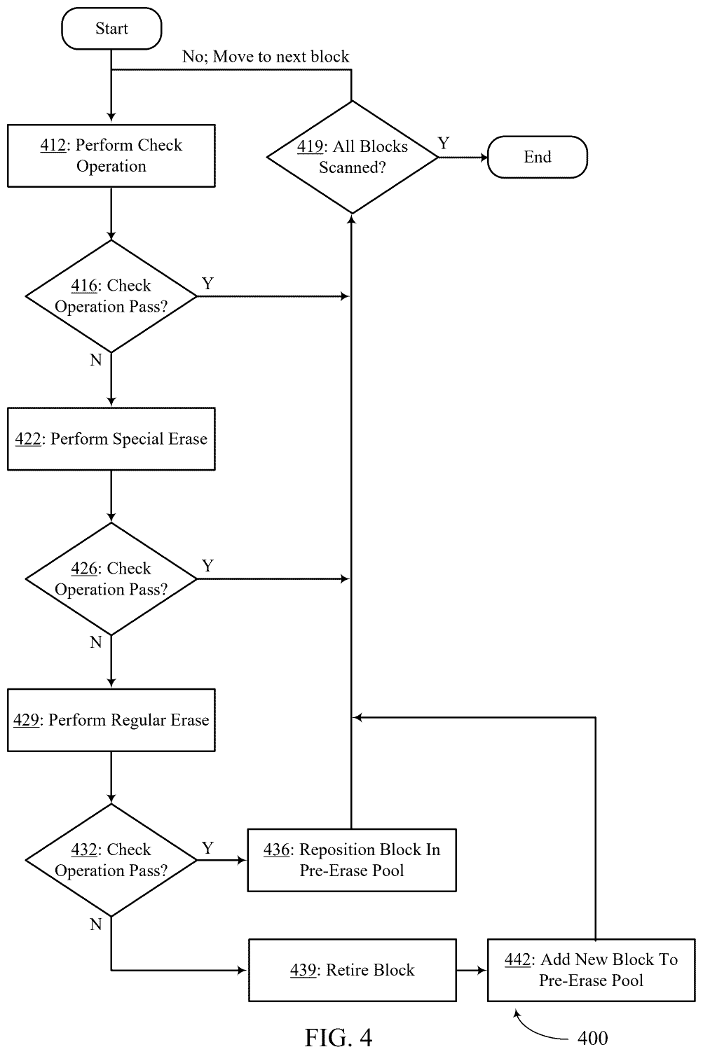

FIG. 4 shows an example of a set of operations for pre-erasing memory blocks in accordance with examples as disclosed herein.

The flowchart 400 may be performed by a memory system, which may be an example of a memory system 110 described herein. In some examples, the flowchart 400 shows an example set of operations performed to support pre-erasing memory blocks. For example, the flowchart 400 may include operations for scanning pre-erased memory blocks in a pre-erase pool (e.g., which may be included in the pre-erase pool in accordance with the operations at FIGS. 2 and 3) to confirm whether a sufficient RWB margin improvement has been achieved for the pre-erased memory blocks.

In some examples, a periodic scanning operation is performed to confirm whether the memory blocks in a pre-erase pool are providing an RWB margin benefit that is above a threshold.

At 412, an operation (which may be referred to as a “check operation”) for confirming whether high-density memory blocks in a pre-erase pool are associated with an RWB margin that is greater than a threshold RWB margin may be performed. In some examples, the check operation includes reading a high-density memory block of the high-density memory blocks and, for example, determining a bit error rate for the high-density memory block. In some examples, the check operation may estimate an RWB margin based on the bit error rate. For example, the check operation may determine the RWB margin is above a threshold if the bit error rate is below a threshold, and vice versa.

In some examples, the check operation includes analyzing the threshold voltages of the memory cells in the high-density memory block and, for example, identifying a threshold voltage distribution of the memory cells as compared to a read voltage. In some examples, the check operation may determine an RWB margin based on the comparison.

At 416, it may be determined whether the high-density memory block passes the check operation—e.g., whether the high-density memory block has an RWB margin that satisfies a threshold RWB margin.

If the high-density memory block passes the check operation, the scanning operation may proceed to perform, at 419, operations for determining whether all of the high-density memory blocks in the pre-erase pool have been scanned. If, at 419, it is determined that all of the high-density memory blocks in the pre-erase pool have been scanned, the scanning operation may conclude. Otherwise, if it is determined that there are high-density memory blocks in the pre-erase pool that have not been scanned, the scanning operation may proceed to perform, at 412 and 416, the previously described check operations for the next high-density memory block in the pre-erase pool.

Otherwise, if the high-density memory block fails the check operation, the scanning operation may proceed to perform a special erase function.

At 422, a special erase function may be performed for the high-density memory block—in accordance with the high-density memory block failing the check operation. In some examples, the special erase function is a modified (e.g., shortened) erase operation. In some examples, the special erase function may involve applying voltages to the memory cells such that the threshold voltages of the memory cells in the memory block are slightly modified (e.g., touched up) without significantly changing the threshold voltage levels of the memory cells—e.g., without causing all the memory cells to have a same threshold voltage (which may also be referred to as erasing the memory block) and/or without modifying the logic states of the memory cells.

At 426, the check operation may again be performed for the high-density memory block—e.g., as described with reference to the operations described at 412 and 416.

If the high-density memory block passes the check operation, the scanning operation may proceed to perform, at 419, the previously described operations. In some examples (e.g., due to the touching-up nature of the special erase function), the high-density memory block may be maintained at its current position within the pre-erase pool—e.g., rather than moving the high-density memory block to an end of the pre-erase pool. That is, the high-density memory block may not need to re-observe the full pre-erase duration threshold prior to a subsequent programming operation to attain the RWB margin benefit.

Otherwise, if the high-density memory block fails the check operation, the scanning operation may proceed to perform a regular erase function.

At 429, a regular erase function may be performed for the high-density memory block—in accordance with the high-density memory block failing the second check operation. The regular erase function operation may involve fully erasing the high-density memory block.

At 432, the check operation may again be performed for the high-density memory block—e.g., as described with reference to the operations described at 412 and 416.

If the high-density memory block passes the check operation, the scanning operation may proceed to perform, at 436, operations for repositioning the high-density memory block at an end of the pre-erase pool—e.g., to ensure the high-density memory block observes the pre-erase threshold duration prior to a subsequent programming operation. In some examples, repositioning the high-density memory block at the end of the pre-erase pool ensures that the high-density memory block will not be programmed before the repositioned high-density memory block observes the pre-erase threshold duration—e.g., if the time for fully programming (e.g., consuming) high-density memory blocks times a quantity of pending high-density memory blocks ahead of the repositioned memory block in the memory pool is greater than the pre-erase threshold duration. In some examples, once the repositioned high-density memory block resides in the pre-erase pool for the pre-erase threshold duration, the repositioned high-density memory block may again be repositioned in a portion of the pre-erase pool that holds pre-erase blocks that are eligible for programming to store data. After repositioning the high-density memory block, the scanning operation may proceed to perform, at 419, the previously described operations.

Otherwise, if the high-density memory block fails the check operation, the scanning operation may proceed to retire the high-density memory block.

At 439, the high-density memory block may be retired. In some examples, the high-density memory block may be retired from high-density operations, pre-erase pool operations, or a combination thereof. In some examples, retiring the high-density memory block may include returning the high-density memory block to the free pool. In some examples, retiring the high-density memory block may include reconfiguring the high-density memory block for other memory operations, such as an SLC caching operation. In such cases, the high-density memory block may be converted to a caching memory block.

At 442, based on removing the high-density memory block from the pre-erase pool, an available “free” high-density memory block may be pre-erased and added to the pre-erase pool (e.g., to the end of the pre-erase pool). Based on adding the new high-density memory block to the pre-erase pool, the scanning operation may proceed to perform, at 419, the previously described operations.

Aspects of the flowchart 400 may be implemented by a controller, among other components. Additionally, or alternatively, aspects of the flowchart 400 may be implemented as instructions stored in memory (e.g., firmware stored in a memory coupled with a controller). For example, the instructions, when executed by a controller, may cause the controller to perform the operations of the flowchart 400.

One or more of the operations described in the flowchart 400 may be performed earlier or later, omitted, replaced, supplemented, or combined with another operation. Also, additional operations described herein may replace, supplement or be combined with one or more of the operations described in the flowchart 400.

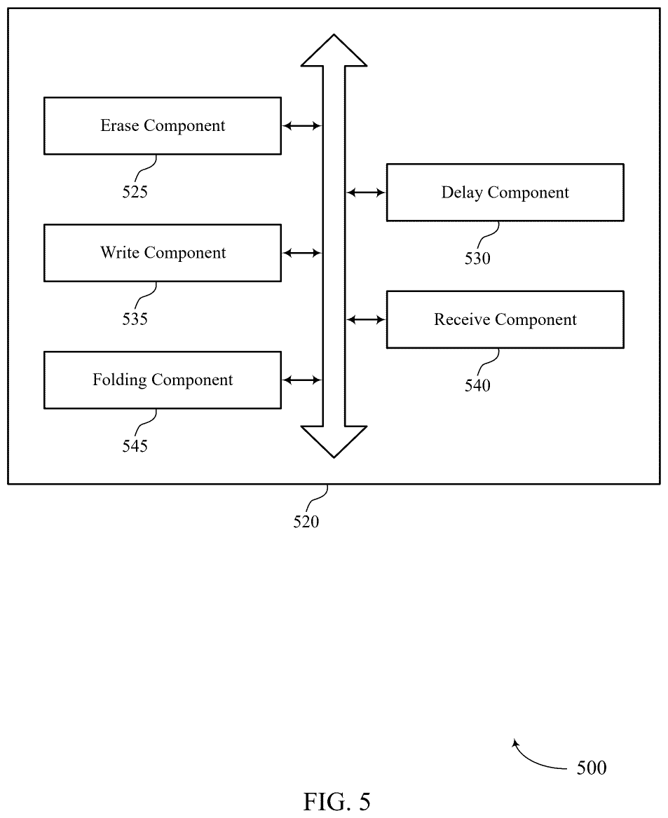

FIG. 5 shows a block diagram 500 of a memory system 520 that supports pre-erasing memory blocks in accordance with examples as disclosed herein. The memory system 520 may be an example of aspects of a memory system as described with reference to FIGS. 1 through 4. The memory system 520, or various components thereof, may be an example of means for performing various aspects of pre-erasing memory blocks as described herein. For example, the memory system 520 may include an crase component 525, a delay component 530, a write component 535, a receive component 540, a folding component 545, or any combination thereof. Each of these components, or components of subcomponents thereof (e.g., one or more processors, one or more memories), may communicate, directly or indirectly, with one another (e.g., via one or more buses).

The erase component 525 may be configured as or otherwise support a means for erasing a plurality of memory cells of a plurality of available memory cells to obtain a plurality of erased memory cells. The delay component 530 may be configured as or otherwise support a means for delaying a subsequent write operation of the plurality of erased memory cells for a duration. The write component 535 may be configured as or otherwise support a means for writing, in accordance with delaying the subsequent write operation of the plurality of erased memory cells for the duration, data to a set of erased memory cells of the plurality of erased memory cells.

In some examples, the receive component 540 may be configured as or otherwise support a means for receiving a write command to write a set of data to the memory system, where the plurality of memory cells are erased in response to the write command.

In some examples, the write component 535 may be configured as or otherwise support a means for writing, in response to the write command and concurrently with erasing the plurality of memory cells, the set of data to a second plurality of memory cells of the plurality of available memory cells. In some examples, the folding component 545 may be configured as or otherwise support a means for transferring the set of data from the second plurality of memory cells to the plurality of memory cells after the plurality of erased memory cells have been erased for the duration, where the set of erased memory cells is written as part of the transferring.

In some examples, the plurality of memory cells are memory cells of a first order, and the second plurality of memory cells are memory cells of a second order that is lower than the first order.

In some examples, the first plurality of memory cells include tri-level memory cells, quad-level memory cells, or both, and the second plurality of memory cells include single-level memory cells, bi-level memory cells, or both.

In some examples, the first plurality of memory cells include quad-level memory cells, and the second plurality of memory cells include tri-level memory cells.

In some examples, the erase component 525 may be configured as or otherwise support a means for calculating a consumption rate of the plurality of available memory cells. In some examples, the erase component 525 may be configured as or otherwise support a means for selecting, in accordance with the consumption rate and the duration, a quantity of the plurality of memory cells of the plurality of available memory cells to erase.

In some examples, the quantity of the plurality of memory cells to erase is selected to ensure that, prior to the write operation, the set of erased memory cells is erased for at least the duration.

In some examples, the receive component 540 may be configured as or otherwise support a means for receiving, after erasing the plurality of available memory cells, a write command to write a set of data to the memory system. In some examples, the write component 535 may be configured as or otherwise support a means for writing, in response to the write command, the set of data to a first set of memory cells of the plurality of available memory cells. In some examples, the folding component 545 may be configured as or otherwise support a means for transferring, as a result of writing the set of data to the first set of memory cells, a second set of data stored in a second set of memory cells to the set of erased memory cells in accordance with the set of erased memory cells being erased longer than the remaining erased memory cells of the plurality of erased memory cells.

In some examples, the erase component 525 may be configured as or otherwise support a means for determining, after delaying the plurality of erased memory cells, read window budget characteristics for pluralities of erased memory cells.

In some examples, the erase component 525 may be configured as or otherwise support a means for determining, in accordance with determining the read window budget characteristics, that a read window budget of the plurality of erased memory cells is below a read window budget threshold. In some examples, the erase component 525 may be configured as or otherwise support a means for re-erasing, in accordance with the read window budget being below the read window budget threshold, the plurality of erased memory cells using a first erasing technique.

In some examples, the erase component 525 may be configured as or otherwise support a means for determining, that the read window budget of the plurality of erased memory cells remains below the read window budget threshold after using the first erasing technique. In some examples, the erase component 525 may be configured as or otherwise support a means for re-erasing, in accordance with the read window budget remaining below the read window budget threshold, the plurality of erased memory cells using a second erasing technique.

In some examples, the delay component 530 may be configured as or otherwise support a means for marking, in accordance with the read window budget satisfying the read window budget threshold, the plurality of erased memory cells as the latest erased plurality of erased memory cells.

In some examples, the erase component 525 may be configured as or otherwise support a means for removing, in accordance with the read window budget satisfying the read window budget threshold, the plurality of erased memory cells from a pre-erase pool. In some examples, the erase component 525 may be configured as or otherwise support a means for erasing a second plurality of memory cells of the plurality of available memory cells to obtain a second plurality of erased memory cells to replace the plurality of erased memory cells in the pre-erase pool.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

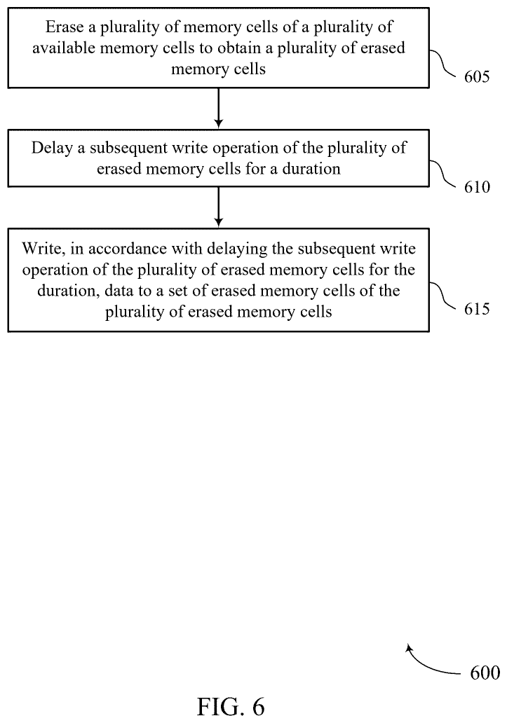

FIG. 6 shows a flowchart illustrating a method 600 that supports pre-erasing memory blocks in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include erasing a plurality of memory cells of a plurality of available memory cells to obtain a plurality of erased memory cells. In some examples, aspects of the operations of 605 may be performed by an erase component 525 as described with reference to FIG. 5.

At 610, the method may include delaying a subsequent write operation of the plurality of erased memory cells for a duration. In some examples, aspects of the operations of 610 may be performed by a delay component 530 as described with reference to FIG. 5.

At 615, the method may include writing, in accordance with delaying the subsequent write operation of the plurality of erased memory cells for the duration, data to a set of erased memory cells of the plurality of erased memory cells. In some examples, aspects of the operations of 615 may be performed by a write component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for erasing a plurality of memory cells of a plurality of available memory cells to obtain a plurality of erased memory cells; delaying a subsequent write operation of the plurality of erased memory cells for a duration; and writing, in accordance with delaying the subsequent write operation of the plurality of erased memory cells for the duration, data to a set of erased memory cells of the plurality of erased memory cells.

Aspect 2: The method, apparatus, or non-transitory computer-readable medium of aspect 1, further including operations, features, circuitry, logic, means, or instructions, or any combination thereof for receiving a write command to write a set of data to the memory system, where the plurality of memory cells are erased in response to the write command.

Aspect 3: The method, apparatus, or non-transitory computer-readable medium of aspect 2, further including operations, features, circuitry, logic, means, or instructions, or any combination thereof for writing, in response to the write command and concurrently with erasing the plurality of memory cells, the set of data to a second plurality of memory cells of the plurality of available memory cells and transferring the set of data from the second plurality of memory cells to the plurality of memory cells after the plurality of erased memory cells have been erased for the duration, where the set of erased memory cells is written as part of the transferring.

Aspect 4: The method, apparatus, or non-transitory computer-readable medium of aspect 3, where the plurality of memory cells are memory cells of a first order, and the second plurality of memory cells are memory cells of a second order that is lower than the first order.

Aspect 5: The method, apparatus, or non-transitory computer-readable medium of aspect 4, where the first plurality of memory cells include tri-level memory cells, quad-level memory cells, or both, and the second plurality of memory cells include single-level memory cells, bi-level memory cells, or both.

Aspect 6: The method, apparatus, or non-transitory computer-readable medium of any of aspects 4 through 5, where the first plurality of memory cells include quad-level memory cells, and the second plurality of memory cells include tri-level memory cells.

Aspect 7: The method, apparatus, or non-transitory computer-readable medium of any of aspects 1 through 6, further including operations, features, circuitry, logic, means, or instructions, or any combination thereof for calculating a consumption rate of the plurality of available memory cells and selecting, in accordance with the consumption rate and the duration, a quantity of the plurality of memory cells of the plurality of available memory cells to erase.

Aspect 8: The method, apparatus, or non-transitory computer-readable medium of aspect 7, where the quantity of the plurality of memory cells to erase is selected to ensure that, prior to the write operation, the set of erased memory cells is erased for at least the duration.

Aspect 9: The method, apparatus, or non-transitory computer-readable medium of any of aspects 7 through 8, further including operations, features, circuitry, logic, means, or instructions, or any combination thereof for receiving, after erasing the plurality of available memory cells, a write command to write a set of data to the memory system; writing, in response to the write command, the set of data to a first set of memory cells of the plurality of available memory cells; and transferring, as a result of writing the set of data to the first set of memory cells, a second set of data stored in a second set of memory cells to the set of erased memory cells in accordance with the set of erased memory cells being erased longer than the remaining erased memory cells of the plurality of erased memory cells.

Aspect 10: The method, apparatus, or non-transitory computer-readable medium of any of aspects 1 through 9, further including operations, features, circuitry, logic, means, or instructions, or any combination thereof for determining, after delaying the plurality of erased memory cells, read window budget characteristics for pluralities of erased memory cells.

Aspect 11: The method, apparatus, or non-transitory computer-readable medium of aspect 10, further including operations, features, circuitry, logic, means, or instructions, or any combination thereof for determining, in accordance with determining the read window budget characteristics, that a read window budget of the plurality of erased memory cells is below a read window budget threshold and re-erasing, in accordance with the read window budget being below the read window budget threshold, the plurality of erased memory cells using a first erasing technique.

Aspect 12: The method, apparatus, or non-transitory computer-readable medium of aspect 11, further including operations, features, circuitry, logic, means, or instructions, or any combination thereof for determining, that the read window budget of the plurality of erased memory cells remains below the read window budget threshold after using the first erasing technique and re-erasing, in accordance with the read window budget remaining below the read window budget threshold, the plurality of erased memory cells using a second erasing technique.

Aspect 13: The method, apparatus, or non-transitory computer-readable medium of aspect 12, further including operations, features, circuitry, logic, means, or instructions, or any combination thereof for marking, in accordance with the read window budget satisfying the read window budget threshold, the plurality of erased memory cells as the latest erased plurality of erased memory cells.

Aspect 14: The method, apparatus, or non-transitory computer-readable medium of any of aspects 12 through 13, further including operations, features, circuitry, logic, means, or instructions, or any combination thereof for removing, in accordance with the read window budget satisfying the read window budget threshold, the plurality of erased memory cells from a pre-erase pool and erasing a second plurality of memory cells of the plurality of available memory cells to obtain a second plurality of erased memory cells to replace the plurality of erased memory cells in the pre-erase pool.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
erase a plurality of memory cells of a plurality of available memory cells to obtain a plurality of erased memory cells;
delay a subsequent write operation of the plurality of erased memory cells for a duration; and
write, in accordance with delaying the subsequent write operation of the plurality of erased memory cells for the duration, data to a set of erased memory cells of the plurality of erased memory cells.

2. The memory system of claim 1, wherein the processing circuitry is further configured to cause the memory system to:
receive a write command to write a set of data to the memory system, wherein the plurality of memory cells are erased in response to the write command.

3. The memory system of claim 2, wherein the processing circuitry is further configured to cause the memory system to:
write, in response to the write command and concurrently with erasing the plurality of memory cells, the set of data to a second plurality of memory cells of the plurality of available memory cells; and
transfer the set of data from the second plurality of memory cells to the plurality of memory cells after the plurality of erased memory cells have been erased for the duration, wherein the set of erased memory cells is written as part of the transferring.

4. The memory system of claim 3, wherein:
the plurality of memory cells are memory cells of a first order, and
the second plurality of memory cells are memory cells of a second order that is lower than the first order.

5. The memory system of claim 4, wherein:
the plurality of memory cells comprise tri-level memory cells, quad-level memory cells, or both, and
the second plurality of memory cells comprise single-level memory cells, bi-level memory cells, or both.

6. The memory system of claim 4, wherein:
the plurality of memory cells comprise quad-level memory cells, and
the second plurality of memory cells comprise tri-level memory cells.

7. The memory system of claim 1, wherein the processing circuitry is further configured to cause the memory system to:
calculate a consumption rate of the plurality of available memory cells; and
select, in accordance with the consumption rate and the duration, a quantity of the plurality of memory cells of the plurality of available memory cells to erase.

8. The memory system of claim 7, wherein the quantity of the plurality of memory cells to erase is selected to ensure that, prior to the subsequent write operation, the set of erased memory cells is erased for at least the duration.

9. The memory system of claim 7, wherein the processing circuitry is further configured to cause the memory system to:
receive, after erasing the plurality of available memory cells, a write command to write a set of data to the memory system;
write, in response to the write command, the set of data to a first set of memory cells of the plurality of available memory cells; and
transfer, as a result of writing the set of data to the first set of memory cells, a second set of data stored in a second set of memory cells to the set of erased memory cells in accordance with the set of erased memory cells being erased longer than the remaining erased memory cells of the plurality of erased memory cells.

10. The memory system of claim 1, wherein the processing circuitry is further configured to cause the memory system to:
determine, after delaying the plurality of erased memory cells, read window budget characteristics for pluralities of erased memory cells.

11. The memory system of claim 10, wherein the processing circuitry is further configured to cause the memory system to:
determine, in accordance with determining the read window budget characteristics, that a read window budget of the plurality of erased memory cells is below a read window budget threshold; and
re-erase, in accordance with the read window budget being below the read window budget threshold, the plurality of erased memory cells using a first erasing technique.

12. The memory system of claim 11, wherein the processing circuitry is further configured to cause the memory system to:
determine, that the read window budget of the plurality of erased memory cells remains below the read window budget threshold after using the first erasing technique; and
re-erase, in accordance with the read window budget remaining below the read window budget threshold, the plurality of erased memory cells using a second erasing technique.

13. The memory system of claim 12, wherein the processing circuitry is further configured to cause the memory system to:
mark, in accordance with the read window budget satisfying the read window budget threshold, the plurality of erased memory cells as the latest erased plurality of erased memory cells.

14. The memory system of claim 12, wherein the processing circuitry is further configured to cause the memory system to:
remove, in accordance with the read window budget satisfying the read window budget threshold, the plurality of erased memory cells from a pre-erase pool; and
erase a second plurality of memory cells of the plurality of available memory cells to obtain a second plurality of erased memory cells to replace the plurality of erased memory cells in the pre-erase pool.

15. A non-transitory, computer-readable medium storing code comprising instructions executable by processing circuitry of a memory system to cause the memory system to:
erase a plurality of memory cells of a plurality of available memory cells to obtain a plurality of erased memory cells;
delay a subsequent write operation of the plurality of erased memory cells for a duration; and
write, in accordance with delaying the subsequent write operation of the plurality of erased memory cells for the duration, data to a set of erased memory cells of the plurality of erased memory cells.

16. The memory system of claim 15, wherein the instructions are further executable by the processing circuitry to cause the memory system to:
receive a write command to write a set of data to the memory system, wherein the plurality of memory cells are erased in response to the write command.

17. The memory system of claim 16, wherein the instructions are further executable by the processing circuitry to cause the memory system to:
write, in response to the write command and concurrently with erasing the plurality of memory cells, the set of data to a second plurality of memory cells of the plurality of available memory cells; and
transfer the set of data from the second plurality of memory cells to the plurality of memory cells after the plurality of erased memory cells have been erased for the duration, wherein the set of erased memory cells is written as part of the transferring.

18. The memory system of claim 17, wherein:
the plurality of memory cells are multiple-level memory cells, and
the second plurality of memory cells are single-level memory cells.

19. The memory system of claim 15, wherein the instructions are further executable by the processing circuitry to cause the memory system to:
calculate a consumption rate of the plurality of available memory cells; and
select, in accordance with the consumption rate and the duration, a quantity of the plurality of memory cells of the plurality of available memory cells to erase.

20. The memory system of claim 19, wherein the instructions are further executable by the processing circuitry to cause the memory system to:
receive, after erasing the plurality of available memory cells, a write command to write a set of data to the memory system;
write, in response to the write command, the set of data to a first set of memory cells of the plurality of available memory cells; and
transfer, as a result of writing the set of data to the first set of memory cells, a second set of data stored in a second set of memory cells to the set of erased memory cells in accordance with the set of erased memory cells being erased longer than the remaining erased memory cells of the plurality of erased memory cells.

21. The memory system of claim 15, wherein the instructions are further executable by the processing circuitry to cause the memory system to:
determine, after delaying the plurality of erased memory cells, read window budget characteristics for pluralities of erased memory cells.

22. A method at a memory system, comprising:
erasing a plurality of memory cells of a plurality of available memory cells to obtain a plurality of erased memory cells;
delaying a subsequent write operation of the plurality of erased memory cells for a duration; and
writing, in accordance with delaying the subsequent write operation of the plurality of erased memory cells for the duration, data to a set of erased memory cells of the plurality of erased memory cells.

23. The method of claim 22, further comprising:
receiving a write command to write a set of data to the memory system, wherein the plurality of memory cells are erased in response to the write command.

24. The method of claim 23, further comprising:
writing, in response to the write command and concurrently with erasing the plurality of memory cells, the set of data to a second plurality of memory cells of the plurality of available memory cells; and
transferring the set of data from the second plurality of memory cells to the plurality of memory cells after the plurality of erased memory cells have been erased for the duration, wherein the set of erased memory cells is written as part of the transferring.

25. The method of claim 22, further comprising:
calculating a consumption rate of the plurality of available memory cells; and
selecting, in accordance with the consumption rate and the duration, a quantity of the plurality of memory cells of the plurality of available memory cells to erase.
